(19) United States
(12) Patent Application Publication
(10) Pub. No.: US 2009/0046610 A1
(43) Pub. Date: Feb. 19, 2009

(54) COMMUNICATION SYSTEM

(75) Inventor: Masato Yamaji, Tokyo (JP)

Correspondence Address: SUGHRUE-265550, 2100 PENNSYLVANIA AVE. NW, WASHINGTON, DC, 20037-3213, US

(73) Assignee: YOKOGAWA ELECTRIC CORPORATION, Musashino-shi (JP)

(21) Appl. No.: 11/817,971

(22) PCT Filed: Mar. 6, 2006
(86) PCT No.: PCT/JP2006/304287

§ 371 Date: Nov. 8, 2007

(30) Foreign Application Priority Data
Mar. 7, 2005 (JP) 2005-062977

(51) Int. Cl. G08C 17/00

(52) U.S. Cl. 370/311

(57) ABSTRACT

A communication system has a sensor node which is driven by a battery, and which is switched in a predetermined cycle from a sleep mode to an active mode to perform data collection, a base station which transmits and receives data to and from the sensor node by wireless communication, and a monitoring device which transmits and receives data to and from the base station by wireless communication or by wired communication. The base station has a storage portion which stores a command from the monitoring device and a proxy portion which notifies the monitoring device of reception of the command, and which transmits a command stored in the storage portion to the sensor node in response to a request from the sensor node.

### TECHNICAL FIELD

The present invention relates to a communication system in which a sensor node and a monitoring device perform communication via a base station, and the communication between the base station and the sensor node is wireless communication, and particularly to a communication system which exhibits good responsiveness as an entire system even when the sensor node is operated while using a sleep mode.

### BACKGROUND ART

FIG. 10 is a configuration diagram showing a topology of a wireless network of a related art (e.g., see JP-A-2004-312069). In sensor nodes 10(1) to 10(n), various sensors (e.g., a temperature sensor, a pressure sensor, a sensor for checking an open/close condition of a switch, and a sensor for measuring an operating condition of a device to be measured) are mounted. The sensor nodes are operated by means of built-in batteries.

A base station 20 is a node which is upper in order than the sensor nodes 10(1) to 10(n), and connected to the sensor nodes 10(1) to 10(n) in a wireless manner, thereby performing transmission and reception of data. A power supply of the base station 20 has a configuration including a line power so that the operation thereof will not stop because of the shortage of power supply, and the moderate restrictions are imposed as compared with the sensor nodes 10(1) to 10(n). A transceiver and a receiver are always in ON conditions, so that transmission and reception of data can be always performed.

Communications are not performed directly between the sensor nodes 10(1) to 10(n), but are performed via the base station 20 without exception. They are configured in a so-called star topology.

A monitoring device 30 is a node which is upper in order than the base station 20, and connected to the base station 20 in a wireless or wired manner. The monitoring device 30 does not directly communicate with the sensor nodes 10(1) to 10(n). The monitoring device 30 communicates with the sensor nodes (1) to 10(n) via the base station 20 to acquire information collected by the sensor nodes 10(1) to 10(n). The monitoring device 30 performs storage of the information, information process, and display of the information, instructs the sensor nodes 10(1) to 10(n) to perform desired a process, and receives process results. To the monitoring device 30, an electric power is supplied so as not to cause the shortage of power, similarly to the case of the base station 20. Thus, the transmission and reception of data can be always performed.

The operation of such an apparatus will be described with reference to FIG. 11. FIG. 11 is a sequence diagram showing the operation of the system shown in FIG. 10. First, there will be described an operation in which the sensor nodes 10(1) to 10(n) perform a predetermined process at prescribed intervals.

The sensor nodes 10(1) to 10(n) perform data collection in a predetermined cycle (SQ1), and transmit the collected data, information of the own devices, required information of conditions of the own devices, and the like to the monitoring device 30 via the base station 20 as sensor information (SQ2, SQ3). Then, the monitoring device 30 performs an information process of the sensor information, then displays the process results on a display screen, and stores the process results into a storage portion (SQ4). By contrast, the sensor nodes 10(1) to 10(n) wait until the next data collection timing, and again perform data collection (SQ5, SQ1).

Next, there will be described an operation in the case where the upper-order devices instruct the sensor nodes 10(1) to 10(n) to perform a predetermined process asynchronously with the timing of data collection SQ1 during the sequence (SQ1 to SQ5) executed in the predetermined cycle.

The operator inputs a command for instructing the sensor nodes 10(1) to 10(n) to perform a process, through an input device of the monitoring device 30 (SQ6). Then, the monitoring device 30 transmits the command to the sensor nodes 10(1) to 10(n) via the base station 20 (SQ7, SQ8). The sensor nodes 10(1) to 10(n) perform the command process instructed by the command (SQ9), and transmit the process results to the monitoring device 30 via the base station 20 (SQ10, SQ11). Then, the monitoring device 30 displays the process results on the display screen, and stores the results into the storage portion (SQ12).

JP-A-2004-312069 is cited herein as a related art.

### DISCLOSURE OF THE INVENTION

### Problems that the Invention is to Solve

The sensor nodes 10(1) to 10(n) are disposed in predetermined positions (in objects to be measured such as a plant, an office, and an automobile), and are not portable unlike a portable telephone or a PDA in many cases. Therefore, the battery cannot be easily recharged unlike a portable telephone or a PDA, so that it is necessary to exchange the battery. Thus, it takes a lot of troubles and cost for the maintenance.

Accordingly, it is very important to make the battery-operated sensor nodes 10(1) to 10(n) to operate over an extended time period, and therefore a sleep function is usually used. In a period when the information process such as the data collection or the production of sensor information is not performed or in a period when communications with the base station 20 are not performed, the sensor nodes 10(1) to 10(n) are set into the sleep mode. Before the next timing of data collection, the sensor nodes 10(1) to 10(n) wake up and enter an active mode. Then, these operations are repeated.

The time length of the sleep mode is determined depending on the characteristics of the sensor nodes 10(1) to 10(n), and those of the entire communication system. In the case where the change of the object to be measured is large, for example, the cycle of the data collection must be set to be short, and also the sleep time is short. This results in large consumption of the battery, and the operating time is shortened. On the contrary, in the case where the change is small, the cycle of the data collection can be set to be longer, so that the sleep time is extended, and the consumption of the battery can be suppressed. Thus, the operating time can be extended. As described above, the time period of the sleep mode can be determined in a trade-off between the frequency of data collection and the battery life.

In the case where a command is asynchronously transmitted from the monitoring device 30 (SQ6 to SQ8), however, the sensor nodes 10(1) to 10(n) must be always in a ready mode in which data can be always received. It is necessary for at least a receiving circuit such as a receiver to always operate. This causes the battery to be consumed. Also in the sensor nodes 10(1) to 10(n), the wireless transmitting/receiving circuit consumes the largest power. For these reasons, there is a problem that it is difficult to operate the sensor nodes 10(1) to 10(n) over a long time period.

Alternatively, a command from the monitoring device 30 can be temporarily accepted by the base station 20, and wireless communication can be performed after the sensor nodes 10(1) to 10(n) enter the active mode. In the case where the sleep time of the sensor nodes 10(1) to 10(n) is long, however, the response time until the process results are returned (SQ10 to SQ12) requires a prolonged time period. Thus, there is another problem that the responsiveness of the entire system is degraded. Furthermore, there is a further problem that the monitoring device 30 cannot determine which is the reason why there is no response due to the sleep mode of the sensor nodes 10(1) to 10(n), or any abnormality (for example, failure of the sensor nodes 10(1) to 10(n), or communication error).

It is an object of the invention to provide a communication system which exhibits good responsiveness as an entire system even when a sensor node is operated while using a sleep mode.

### Means for Solving the Problems

The invention provides a communication system comprising:

a sensor node which is driven by a battery and is switched in a predetermined cycle from a sleep mode to an active mode to perform data collection;

a base station which transmits and receives data to and from the sensor node by wireless communication; and

a monitoring device which transmits and receives data to and from the base station by wireless communication or by wired communication, wherein

the base station has:

a storage portion which stores a command from the monitoring device; and

a proxy portion which notifies the monitoring device of reception of the command, and which transmits a command stored in the storage portion to the sensor node in response to a request from the sensor node.

In the communication system,

the sensor node requests transmission of a command to the base station in the active mode, and, when the command is not received, enters the sleep mode.

In the communication system,

the sensor node requests transmission of a command to the base station in the active mode, and, after the received command is processed, enters the sleep mode.

In the communication system,

the storage portion of the base station stores data transmitted from the sensor node, and

the proxy portion of the base station transmits data stored in the storage portion to the monitoring device in response to a request from the monitoring device.

In the communication system,

the base station has

a time output portion which adds a time when data transmitted from the sensor node is received, to the data.

In the communication system,

the proxy portion of the base station adds

a timing at which the sensor node enters the active mode, to data to be transmitted to the monitoring device.

In the communication system,

the proxy portion of the base station adds

a timing at which the sensor node enters the active mode, to data to be transmitted to the monitoring device, when reception of the command is to be notified to the monitoring device

### ADVANTAGE OF THE INVENTION

According to the communication system, the following advantages are obtained.

A command transmitted from the monitoring device to the sensor node is stored into the storage portion of the base station, and the proxy portion of the base station notifies the monitoring device of the reception of the command. When the sensor node is in an active mode, the sensor node makes an inquiry about the existence of a command from the monitoring device, to the base station. Then, the sensor node enters the sleep mode. In this way, even when the sensor mode is operated while using a sleep mode, the responsiveness as an entire system can be improved. In addition, the monitoring device can determine the condition whether any abnormality or the like occurs or not.

The storage portion of the base station stores the data from the sensor node. When transmission of data is requested by the monitoring device, the proxy portion of the base station transmits the data in the storage portion to the monitoring device, so that the load of the monitoring device is dispersed. Moreover, the information process in the monitoring device is facilitated.

The time output portion adds the time when the data is received from the sensor node, to the received data, and transmits the data with the time to the monitoring device. Accordingly, the monitoring device can determine how the received data is new, or how long time elapses after the data is produced.

In addition, the proxy portion adds the wake-up time of the sensor node to the data from the sensor node, and then transmits the data to the monitoring device. Thus, the monitoring device can know the time when the latest data can be acquired, and waste data transmission can be suppressed.

Since the proxy portion transmits information of the reception of the command to which the wake-up time of the sensor node is added, to the monitoring device, the monitoring device can determine when the result of the process for the command which is transmitted from the monitoring device itself is executed. Accordingly, it is possible to determine how long the reply to the command is to be waited, and the construction and the production of a management application can be easily performed.

### BRIEF DESCRIPTION OF THE DRAWINGS

FIG. 1 is a configuration diagram showing a first embodiment of the communication system according to the present invention.

FIG. 2 is a view showing an example of the operation of the communication system shown in FIG. 1.

FIG. 3 is a view showing another example of the operation of the communication system shown in FIG. 1.

FIG. 4 is a view showing a further example of the operation of the communication system shown in FIG. 1.

FIG. 5 is a configuration diagram showing a second embodiment of the communication system according to the invention.

FIG. 6 is a view showing an example of the operation of the communication system shown in FIG. 5.

FIG. 7 is a configuration diagram showing a third embodiment of the communication system according to the invention.

FIG. 8 is a view showing an example of the operation of the communication system shown in FIG. 7.

FIG. 9 is a view showing another example of the operation of the communication system shown in FIG. 7.

FIG. 10 is a view showing the configuration of a communication system of a related art.

FIG. 11 is a view showing an example of the operation of the communication system shown in FIG. 10.

### DESCRIPTION OF REFERENCE NUMERALS AND SIGNS

10(1) to 10(n) sensor node
30 monitoring device
40 base station
42 storage portion
43 proxy portion
44 time output portion
45 wake-up time table

### BEST MODE FOR CARRYING OUT THE INVENTION

Hereinafter, embodiments of the invention will be described with reference to the drawings.

### First Embodiment

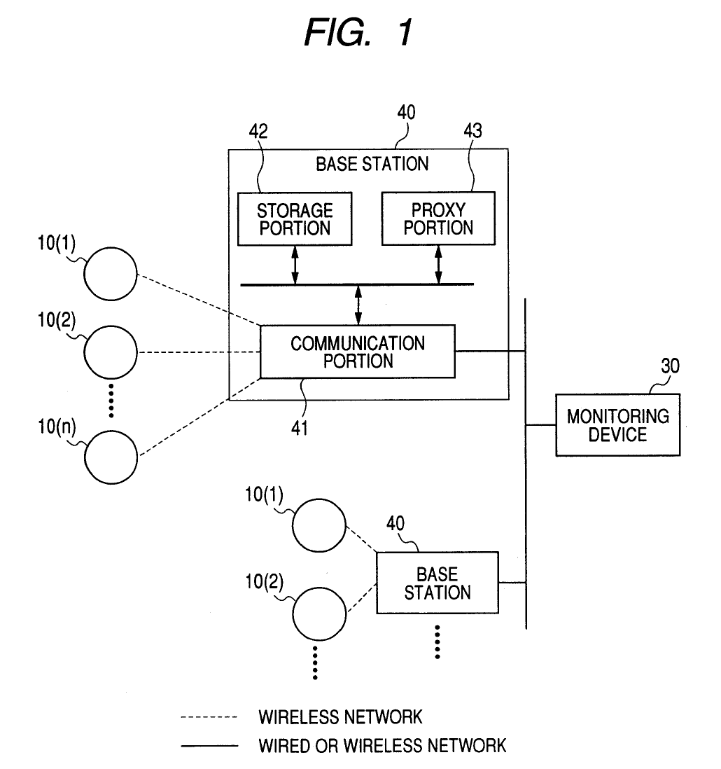

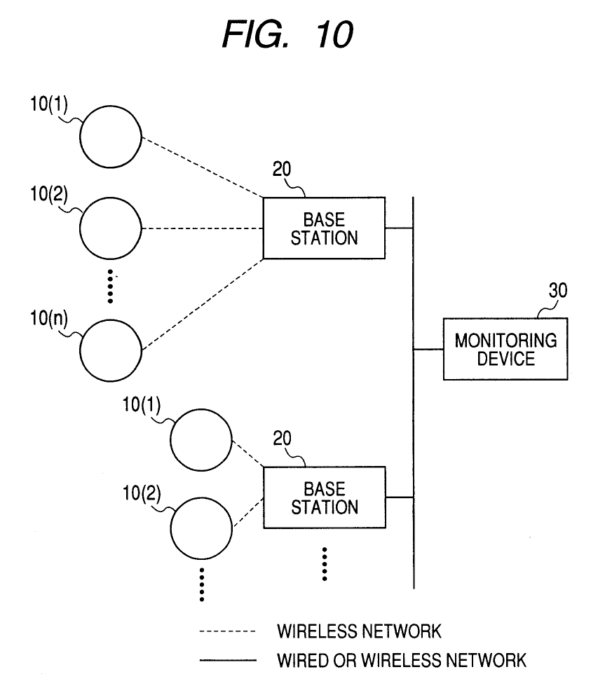

FIG. 1 is a configuration diagram showing a first embodiment of the communication system according to the invention. In the figure, the same components as those in FIG. 10 are denoted by the identical reference numerals, and their description is omitted. Referring to FIG. 1, instead of the base station 20, a base station 40 is disposed. The base station 40 has a communication portion 41, a storage portion 42, and a proxy portion 43. The base station 40 performs wireless communication with sensor nodes 10(1) to 10(n), so as to transmit or receive data, and performs wireless or wired communication with the monitoring device 30, so as to transmit or receive data.

The base station 40 is a node which is upper in order than the sensor nodes 10(1) to 10(n), and which is lower in order than the monitoring device 30. A power supply of the base station 40 has a configuration including a line power so that the operation thereof will not stop because of the shortage of power supply, and moderate restrictions are imposed as compared with the sensor nodes 10(1) to 10(n). The receiver and the transceiver are always in ON conditions, so that the transmission and reception of data are always enabled.

The communication portion 41 has the transceiver, the receiver, and the like, and communicates with the sensor nodes 10(1) to 10(n) and the monitoring device 30. The storage portion 42 is connected to the communication portion 41 via the internal bus, and stores sensor information from the sensor nodes 10(1) to 10(n) and a command from the monitoring device 30, i.e., performs queuing and caching. The proxy portion 43 is connected to the communication portion 41 and the storage portion 42 via the internal bus, and, when a command is received from the monitoring device 30, outputs data indicating the reception as a reception result.

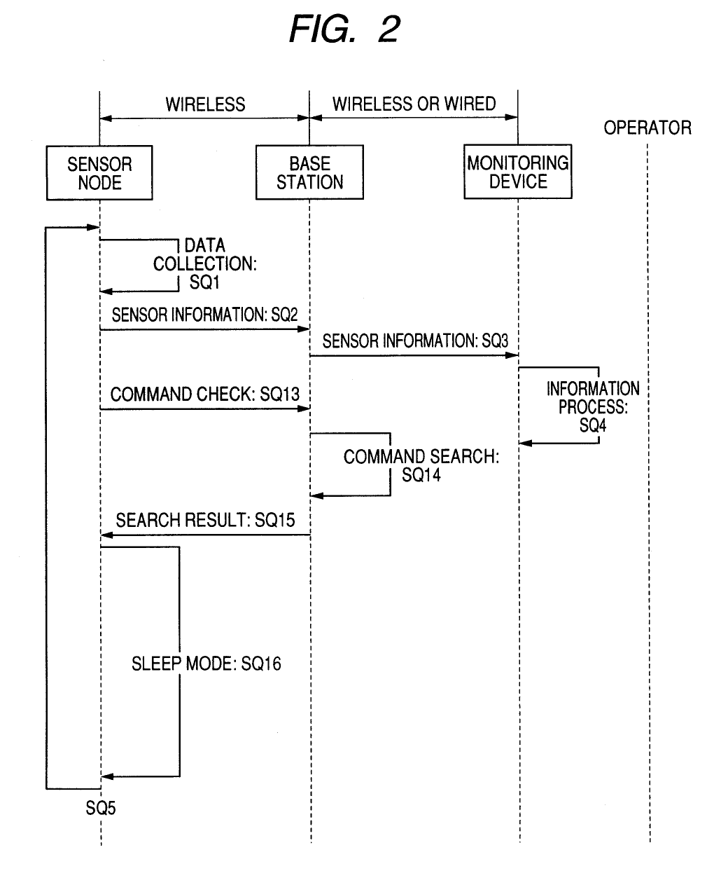

The operation of the apparatus will be described with reference to FIG. 2. FIG. 2 is a sequence diagram showing an example of the operation of the communication system shown in FIG. 1. The description is started from an operation in which the sensor nodes 10(1) to 10(n) perform a predetermined process at prescribed intervals.

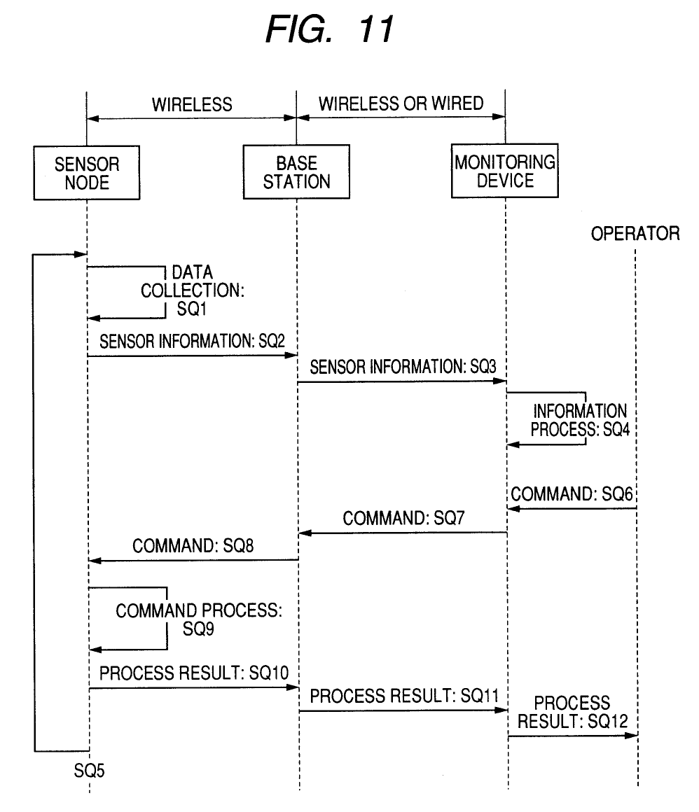

The sensor nodes 10(1) to 10(n) perform data collection in predetermined cycles (SQ1), and transmit the collected data, information of the own devices, required information such as conditions of the own devices to the monitoring device 30 as sensor information via the communication portion 41 of the base station 40 (SQ2, SQ3). Then, the monitoring device 30 performs an information process of the sensor information, then displays the process results on a display screen, and stores the process results into the storage portion (SQ4). These processes are the same as those of the apparatus shown in FIG. 11.

Then, after outputting the sensor information (SQ2), the sensor nodes 10(1) to 10(n) output a command for requesting a command check to the base station 40 (SQ13). In response to the request for the command check, the proxy portion 43 of the base station 40 checks whether a command from the monitoring device 30 is stored in the storage portion 42 or not (SQ14). If any command is not stored, a search result indicating that any command is not stored is output to the sensor nodes 10(1) to 10(n) via the communication portion 41 (SQ15).

If the search result, i.e., a command is not transmitted, the sensor nodes 10(1) to 10(n) enter the sleep mode (SQ16), and wake up at the next data collection timing to again perform the data collection (SQ5, SQ1).

In the sleep mode, devices in the sensor nodes 10(1) to 10(n) (for example, a CPU, the transceiver, the receiver, and the like) consume only the electric power required for the restart (for example, a voltage is lowered to a level minimally required for operating, or an operating frequency is lowered), so that the power consumption of the devices in the sensor nodes 10(1) to 10(n) is reduced. When the sensor nodes are to enter the active mode, the sensor nodes escape from the sleep mode to perform returning to the former conditions, restarting or the like.

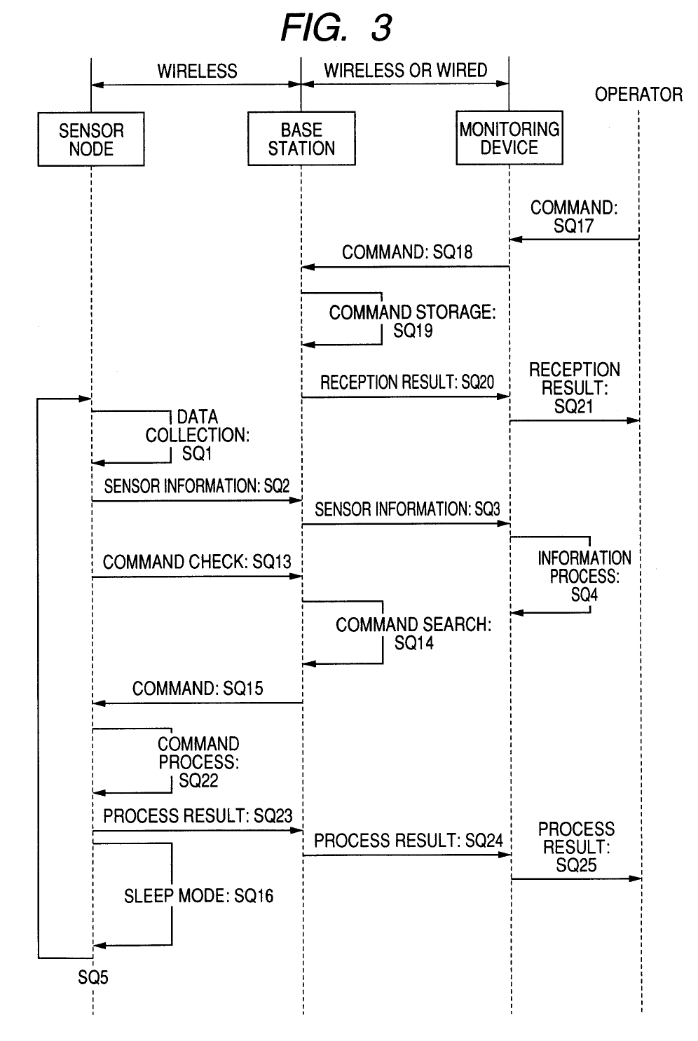

Next, with reference to FIG. 3, there will be described an operation in the case where a upper-order device instructs the sensor nodes 10(1) to 10(n) to perform a predetermined process asynchronously with the timing of the data collection SQ1 in addition to the above-described sequence in which the process is performed in the predetermined cycle (SQ1 to SQ5). FIG. 3 is a sequence diagram showing another example of the operation of the communication system shown in FIG. 1.

The operator inputs a command for causing the sensor nodes 10(1) to 10(n) to perform a process, through the input device of the monitoring device 30 (SQ17). Then, the monitoring device 30 transmits the command to the base station 40 (SQ18). The communication portion 41 of the base station 40 queues the received command to the storage portion 42 (SQ19), and notifies the proxy portion 42 of the reception of the command. The proxy portion 42 sends a reply indicating only the reception of the command, to the monitoring device 30 via the communication portion 41 (SQ20). In addition, the monitoring device 30 displays the process result received from the base station 40 on a display screen, and stores the process result into a storage portion which is not shown (SQ21).

By contrast, in the same manner as FIG. 2, after the output of the sensor information (SQ2), the sensor nodes 10(1) to 10(n) output a command for requesting for a command check to the base station 20 (SQ13). In response to the request of the command check, the proxy portion 43 of the base station 20 checks whether any command from the monitoring device 30 is stored in the storage portion 42 or not (SQ14), and outputs the stored command to the sensor nodes 10(1) to 10(n) via the communication portion 41 (SQ15).

Then, the sensor nodes 10(1) to 10(n) perform a command process of the contents instructed by the command (SQ22), and transmit the process results to the monitoring device 30 via the base station 40 (SQ23, SQ24). Then, the monitoring device 30 displays the process results on the display screen, and stores the process results into the storage portion (SQ25). In addition, after the transmission of the process results, the sensor nodes 10(1) to 10(5) enter the sleep mode similarly to FIG. 2 (SQ16).

As described above, the base station 40 queues and caches a command from the monitoring device 30 to the sensor nodes 10(1) to 10(n), in the storage portion 42, and the proxy portion 43 sends a replay indicative of the reception of the command to the monitoring device 30. On the other hand, in the active mode of the sensor nodes 10(1) to 10(n), the sensor nodes 10(1) to 10(n) make inquiries whether there is a command from the monitoring device 30 or not, to the base station 40. If there is no command, the sensor nodes enter the sleep mode. If there is a command, the sensor nodes enter the sleep mode after the command process. Even when the sensor nodes are operated while using the sleep mode, therefore, the responsiveness of the entire system can be improved. In addition, the monitoring device 30 can determine whether there occurs any abnormality or the like or not.

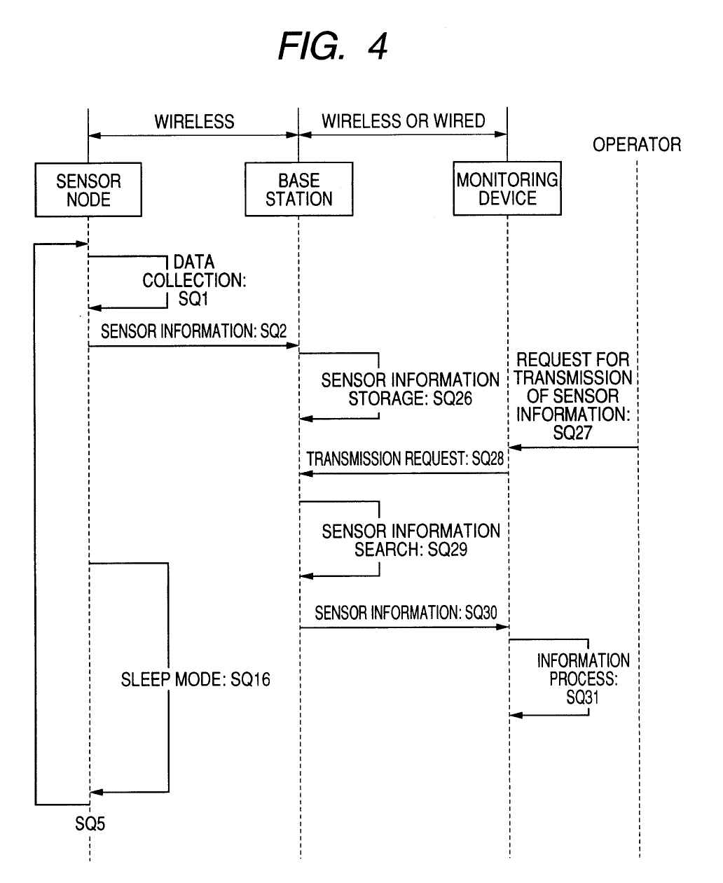

Next, FIG. 4 is a sequence diagram showing another example of the operation of the communication system shown in FIG. 1. FIG. 2 shows the exemplary case where, immediately after the base station 40 receives the sensor information from the sensor nodes 10(1) to 10(n), the sensor information is transmitted to the monitoring device 30. FIG. 4 shows an exemplary case in which the base station 40 temporarily caches the sensor information from the sensor nodes 10(1) to 10(n). In the figure, the same components as those in FIG. 2 are denoted by the identical reference numerals, and their description is omitted. The illustration of the sequences SQ13 to SQ15 is omitted.

The sensor nodes 10(1) to 10(n) perform the data collection in predetermined cycles (SQ1), and transmit the sensor information to the base station 40 (SQ2). The communication portion 41 of the base station 40 caches the received sensor information into the storage portion 42 (SQ26).

The operator inputs a request for transmission of the sensor information through the input device of the monitoring device 30 at a desired timing (SQ27). Then, the monitoring device 30 transmits the transmission request to the base station 40 (SQ28). In response to the transmission request, the proxy portion 42 of the base station 40 searches and reads out sensor information which is not yet transmitted to the monitoring device 30 among the sensor information stored in the storage portion 42 (SQ29), and causes the communication portion 42 to transmit the searched sensor information to the monitoring device 30 (SQ30). In addition, the monitoring device 30 performs an information process on the sensor information received from the base station 40, displays the process result on the display screen, and store the result into the storage portion (SQ31).

It is a matter of course that, in the case shown in FIG. 3, the sensor information may be temporarily cached by the base station 40, and the sensor information may be transmitted in response to the request from the monitoring device 30, similarly to FIG. 4.

As described above, the storage portion 42 of the base station 40 temporarily stores the sensor information from the sensor nodes 10(1) to 10(n). When the transmission of the sensor information is requested by the monitoring device 30, the proxy portion 43 transmits the sensor information in the storage portion 42 to the monitoring device 30, and hence the load of the monitoring device 30 is dispersed. In addition, the information process in the monitoring device 30 is facilitated.

For example, the monitoring device 30 performs the communication with other systems and the management of the entire system, and hence the load condition of the monitoring device is sometimes high and sometimes low. The base station 40 transmits the sensor information to the monitoring device 30 in response to the request from the monitoring device 30. Therefore, the monitoring device 30 takes account the load condition of the own device, and can receive the sensor information in the condition where the load is low, whereby the load can be dispersed.

In the case where the data collection cycle of the sensor nodes 10(1) to 10(n) is about one second, and it is sufficient to perform the information process of the monitoring device 30 at intervals of about several minutes, the communication is performed every one second in the example of FIG. 2, and the transmission amount on a communication path is large. On the contrary, in the example of FIG. 4, the communication can be performed at intervals of several minutes, and the load of the monitoring device 30 can be dispersed. Also in the monitoring device 30, the intervals for performing the information process can be set by the monitoring device 30, and the information process is facilitated.

### Second Embodiment

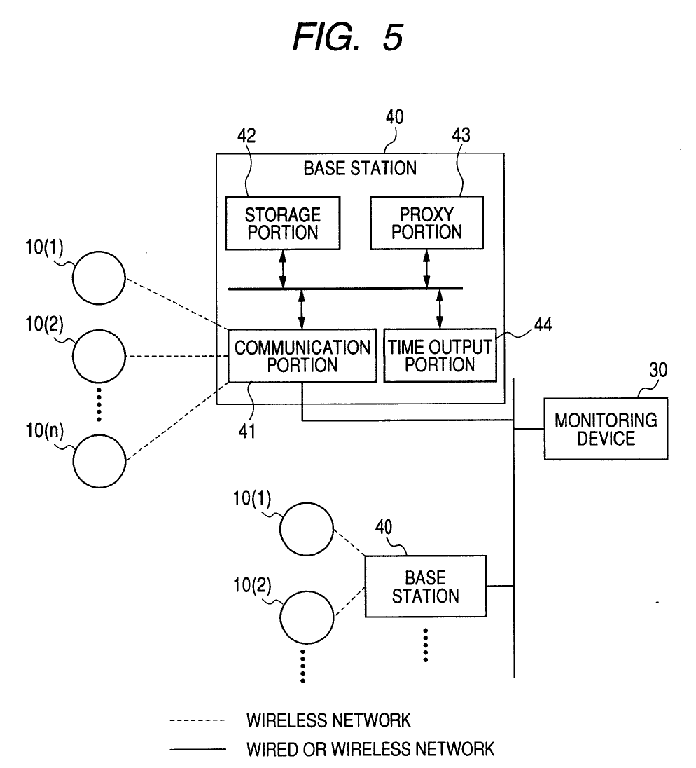

FIG. 5 is a configuration diagram showing a second embodiment of the communication system according to the invention. In the figure, the same components as those in FIG. 1 are denoted by the identical reference numerals, and their description is omitted. Referring to FIG. 5, a time output portion 44 is additionally disposed in the base station 40, and connected to the communication portion 41, the storage portion 42, and the proxy portion 43 via the internal bus. The time output portion 44 outputs the time, and adds the time at which the sensor information is received, to the sensor information from the sensor nodes 10(1) to 10(n).

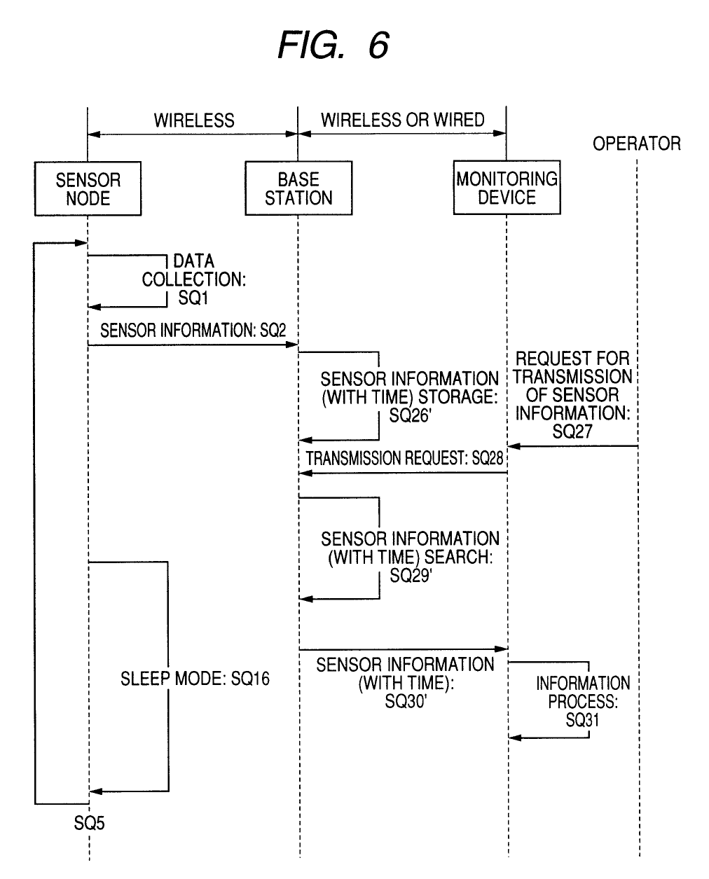

The operation of the above-described apparatus will be described with reference to FIG. 6. The apparatus shown in FIG. 5 operates almost similarly to the apparatus shown in FIG. 1, but the operation is different in that the base station 40 adds a time to the sensor information and transmits the sensor information to which the time is added, to the monitoring device 40. Specifically, when the communication portion 41 of the base station 40 caches the received sensor information into the storage portion 42, the time output portion 44 adds the time at which the sensor information is received, to the sensor information (SQ26′). Then, the proxy portion 42 of the base station 40 searches and reads out the sensor information to which the time is added (SQ29′), and causes the communication portion 42 to transmit the sensor information to which the time is added, to the monitoring device 30 (SQ30′).

As described above, the time output portion 44 adds the time at which the sensor information is received by the base station 40, to the sensor information, and the monitoring device 30 receives the sensor information with the time. Accordingly, the monitoring device 30 can determine how the received sensor information is new, or how long time elapses after the data is produced.

### Third Embodiment

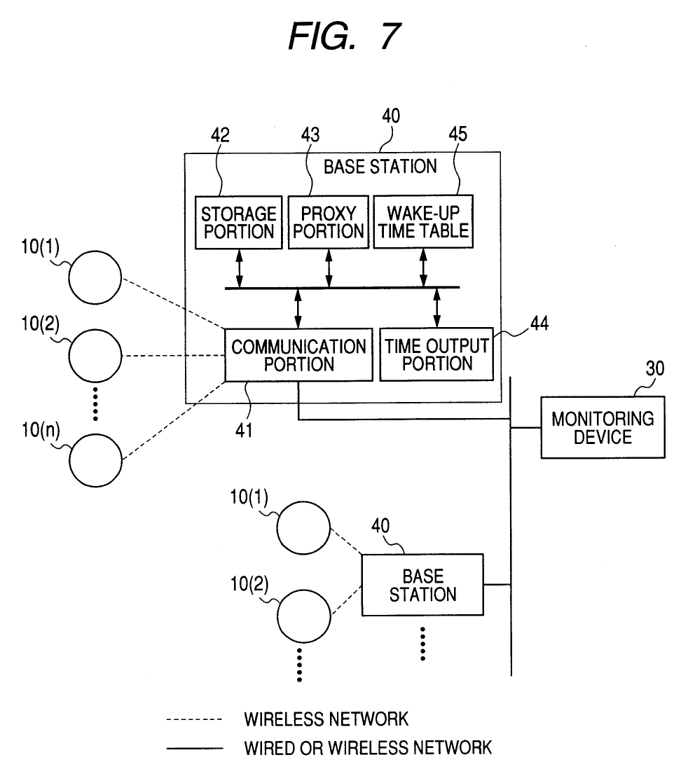

FIG. 7 is a configuration diagram showing a third embodiment of the communication system according to the invention. The same components as those shown in FIG. 5 are denoted by the identical reference numerals, and their description is omitted. Referring to FIG. 5, a wake-up time table 45 is additionally disposed, and connected to the communication portion 41, the storage portion 42, the proxy portion 43, and the time output portion 44 via the internal bus. The wake-up time table 45 is a second storage portion for storing a cycle in which the respective sensor nodes 10(1) to 10(n) wake up and collect data, i.e., a cycle in which the sleep mode is transferred to the active mode.

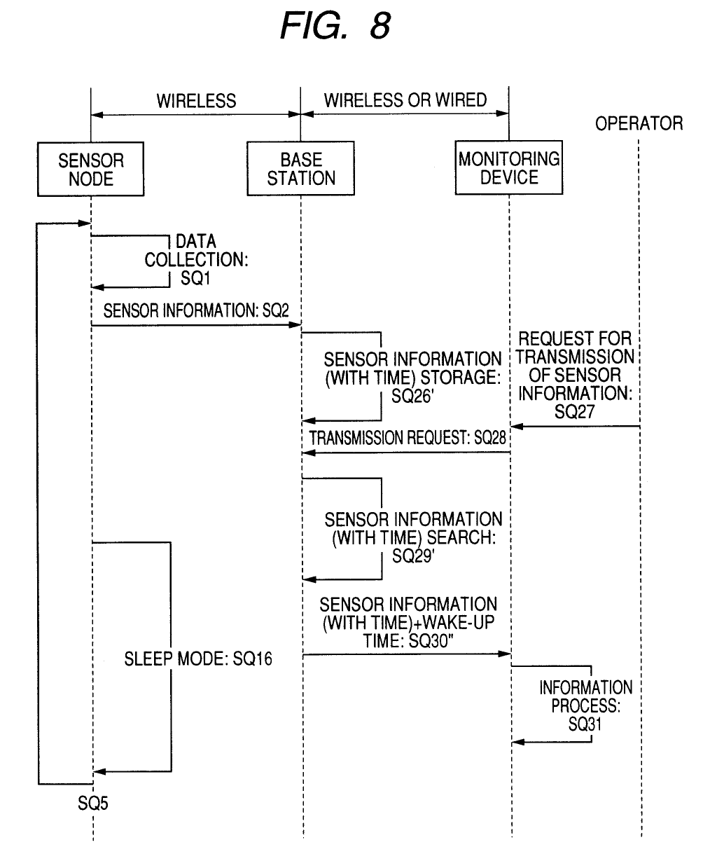

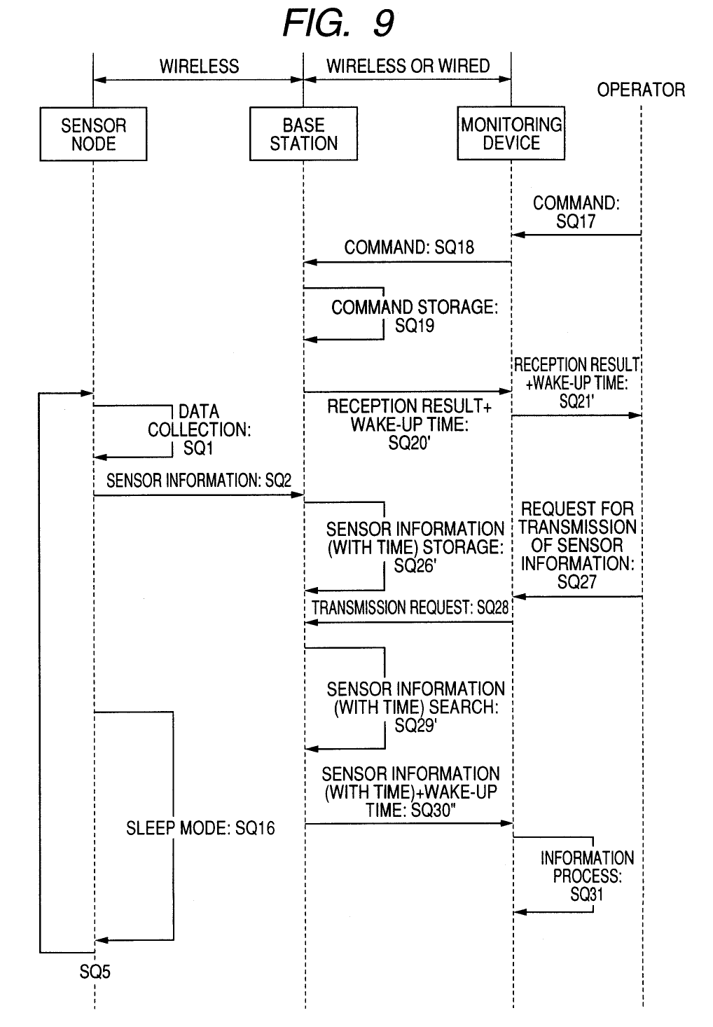

The operation of the above-described apparatus will be described with reference to FIGS. 8 and 9. The apparatus shown in FIG. 7 operates almost similarly to the apparatus shown in FIG. 5, but the operation is different in that, when the proxy portion 43 outputs the sensor information to the monitoring device 30, the proxy portion 43 refers to a data collection cycle of the wake-up time table 45 and a time output from the time output portion 46, adds the time at which the sensor nodes 10(1) to 10(n) will wake up next, and then transmits the sensor information. In addition, the operation is different also in that, when the receiving result indicating that a command is received is output to the monitoring device 30, the proxy portion 43 refers to the data collection cycle of the wake-up time table 45 and the time output from the time output portion 46, adds the time at which the sensor nodes 10(1) to 10(n) will wake up next, and then transmits the receiving result.

Specifically, the proxy portion 42 of the base station 40 causes the communication portion 42 to transmit the sensor information to which the time is added, to the monitoring device 30. The time at which one of the sensor nodes 10(1) to 10(n) corresponding to the sensor information wakes up is obtained from the data collection cycle of the wake-up time table 45 and the time output from the time output portion 46. The wake-up time and the sensor information to which the received time is added are transmitted in combination (SQ30″ in FIGS. 8 and 9).

In the reception result indicative of the reception of the command, the proxy portion 42 obtains the timing at which one of the sensor nodes 10(1) to 10(n) as the command destination will wake up, from the data collection cycle of the wake-up time table 45 and the time output from the time output portion 46, then combines the wake-up time with the sensor information to which the receiving time is added, and replies the combination to the monitoring device 30 via the communication portion 41 (SQ20′, SQ21′ in FIG. 9).

As described above, the proxy portion 43 adds the wake-up times of the sensor nodes 10(1) to 10(n) to the sensor information, and then transmits the sensor information to the monitoring device 30. Therefore, the monitoring device 30 can determine the time at which the latest data can be acquired. Even in the case where the sleep time of the sensor nodes 10(1) to 10(n) is very long, for example, it is possible to prevent the monitoring device 30 from requesting the transmission of the sensor information before the next data collection is performed. Thus, it is possible to suppress waste data transmission.

The proxy portion 43 adds the wake-up times of the sensor nodes 10(1) to 10(n) to the receiving result, and then transmits the receiving result to the monitoring device 30. Therefore, the monitoring device 30 can determine when the process of the command transmitted by the own device 30 is executed. Accordingly, it is possible to determine how long the reply to the command is to be waited, and the construction and the production of a management application can be easily performed.

The invention is not limited to the above-described embodiments, and may be configured in the following manner.

In the communication systems shown in FIGS. 1, 5, and 7, the numbers of the sensor nodes 10(1) to 10(n), the base station 40, and the monitoring device 30 may be optionally determined.

1. A communication system comprising:
a sensor node which is driven by a battery and is switched in a predetermined cycle from a sleep mode to an active mode to perform data collection;
a base station which transmits and receives data to and from said sensor node by wireless communication; and
a monitoring device which transmits and receives data to and from said base station by wireless communication or by wired communication, wherein
said base station has:
a storage portion which stores a command from said monitoring device; and
a proxy portion which notifies said monitoring device of reception of the command, and which transmits a command stored in said storage portion to said sensor node in response to a request from said sensor node.

2. The communication system according to claim 1, wherein said sensor node requests transmission of a command to said base station in the active mode, and, when the command is not received, enters the sleep mode.

3. The communication system according to claim 1, wherein said sensor node requests transmission of a command to said base station in the active mode, and, after the received command is processed, enters the sleep mode.

4. The communication system according to claim 1, wherein
said storage portion of said base station stores data transmitted from said sensor node, and
said proxy portion of said base station transmits data stored in said storage portion to said monitoring device in response to a request from said monitoring device.

5. The communication system according to claim 1, wherein
said base station has
a time output portion which adds a time when data transmitted from said sensor node is received, to the data.

6. The communication system according to claim 5, wherein
said proxy portion of said base station adds
a timing at which said sensor node enters the active mode, to data to be transmitted to said monitoring device.

7. The communication system according to claim 5, wherein
said proxy portion of said base station adds
a timing at which said sensor node enters the active mode, to data to be transmitted to said monitoring device, when reception of the command is to be notified to said monitoring device.
